(19) United States
(12) Patent Application Publication
(10) Pub. No.: US 2014/0313204 A1
(43) Pub. Date: Oct. 23, 2014

(54) ELECTRONIC DEVICE AND METHOD FOR DRIVING RETINA DISPLAY

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventor: HUNG-CHI HUANG, New Taipei (TW)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/156,435

(22) Filed: Jan. 15, 2014

(30) Foreign Application Priority Data
Apr. 19, 2013 (TW) 102113912

(51) Int. Cl. G09G 5/30

(52) U.S. Cl. CPC G09G 5/30
USPC 345/428

(57) ABSTRACT

In a method for driving a retina display of an electronic device, the electronic device includes a graphics input-output (I/O) driver, a video driver, a graphics engine, an I/O manager, and a video adaptor connected to the retina display. The graphics engine detects a retina resolution of the retina display and a standard resolution of an image currently displayed on the retina display, and analyzes a display ratio of the image displayed on the retina display according to the retina resolution when the retina resolution is greater than the standard resolution. The standard resolution is adjusted to the retina resolution according to an image compensation algorithm, and the video driver controls the video adaptor to display the image on the retina display according to the retina resolution and the display ratio.

### BACKGROUND

1. Technical Field

Embodiments of the present disclosure relate to display systems and methods, and particularly to an electronic device and a method for driving a retina display of the electronic device.

2. Description of Related Art

In electronic devices with display screens, an operating system (OS) may define an optimal display resolution of a display screen and a display size of an image displayed on the display screen. If a retina display supporting a higher resolution is used, the display resolution can be manually adjusted to a retina resolution. However, if the display resolution is adjusted to the retina resolution, a display ratio of the image may be distorted. Therefore, there is room for improvement within the art.

### BRIEF DESCRIPTION OF THE DRAWINGS

FIG. 1 is a block diagram of one embodiment of an electronic device comprising a retina display driving system.

FIG. 2 is a block diagram illustrating function modules of the retina display driving system in FIG. 1

FIG. 3 is a flowchart of one embodiment of a method for driving a retina display of the electronic device of FIG. 1.

FIG. 4 is a schematic diagram illustrating one embodiment of an image compensation algorithm used for adjusting a resolution of the retina display.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable media or storage medium. Some non-limiting examples of a non-transitory computer-readable medium comprise CDs, DVDs, flash memory, and hard disk drives.

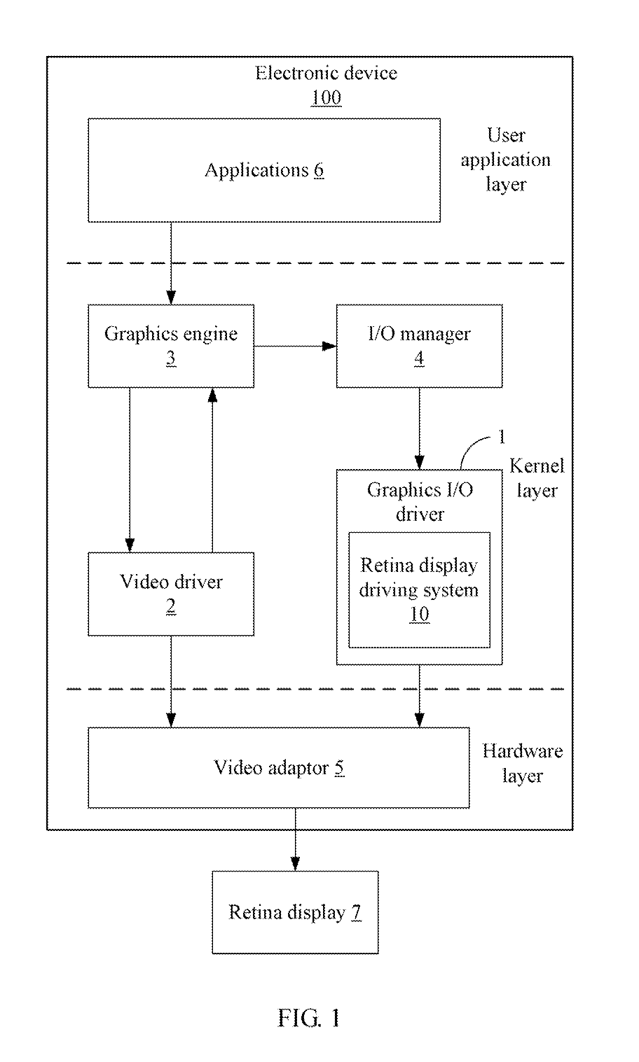

FIG. 1 is a block diagram of one embodiment of an electronic device 100 comprising a retina display driving system 10. In the embodiment, the electronic device 100 includes a user application layer, a kernel layer, and a hardware layer defined by an operating system (OS) mode. The user application layer includes various applications 6 such as image software and an OS of the electronic device 100. The kernel layer includes a graphics input-output (I/O) driver 1, a video driver 2, a graphics engine 3, and an I/O manager 4. The hardware layer includes a video adaptor 5, which connects to a retina display 7. In one embodiment, a display resolution of the retina display 7 can be between a standard resolution, such as 1366*768, and a retina resolution, such as 2732*1536. The retina display 7 is a liquid crystal display (LCD) having a pixel density high enough that individual pixels of the retina display 7 are indiscernible at a typical viewing distance, such as one hundred centimeters.

In the embodiment, the retina display driving system 10 comprises computerized instructions in the form of one or more computer-readable programs, which are embodied in a memory of the graphics I/O driver 1 or stored in a non-transitory computer-readable media or storage medium. The electronic device 100 can be a personal computer, a notebook computer, a server, a mobile device, a personal digital assistant (PDA) device, or the like. FIG. 1 is only one example of the electronic device 100, and other examples may comprise more or fewer components than those shown in the embodiment, or have a different configuration of the various components.

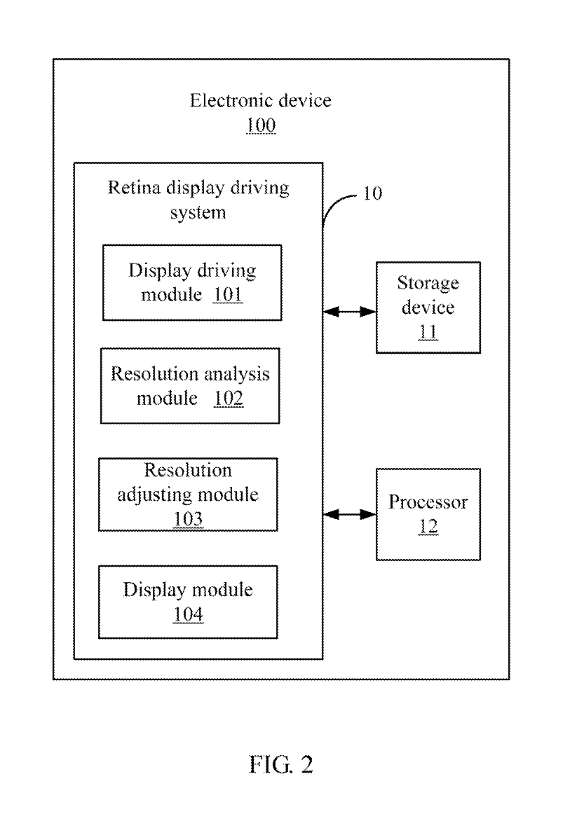

FIG. 2 is a block diagram illustrating function modules of the retina display driving system 10 of the electronic device 100. In the embodiment, the electronic device 100 further includes a storage device 11 and at least one processor 12. The storage device 11 can be an internal storage system, such as a flash memory, a random access memory (RAM) for temporary storage of information, and/or a read-only memory (ROM) for permanent storage of information. The storage device 11 can also be an external storage system, such as an external hard disk, a storage card, or a data storage medium. The at least one processor 12 can be a central processing unit (CPU), a microprocessor, or other data processor chip that performs various functions of the electronic device 100.

In one embodiment, the retina display driving system 10 comprises, but is not limited to, a display driving module 101, a resolution analysis module 102, a resolution adjusting module 103, and a display module 104. The modules 101-104 may comprise computerized instructions in the form of one or more computer-readable programs that are stored in a non-transitory computer-readable medium (such as the storage device 11) and executed by the at least one processor 12 of the electronic device 100. A description of each module is given in the following paragraphs.

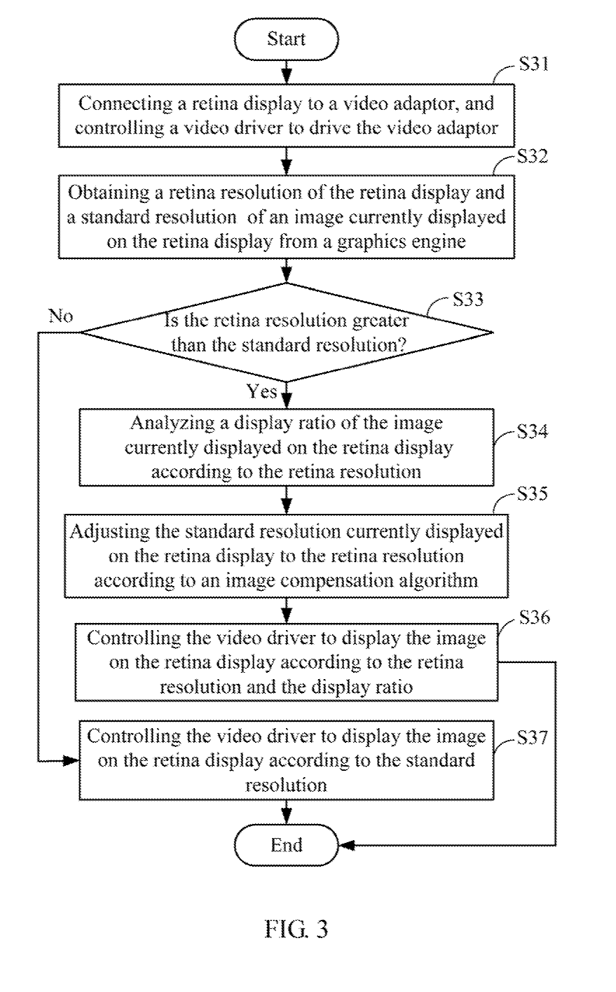

FIG. 3 is a flowchart of one embodiment of a method for driving a retina display of the electronic device 100. In one embodiment, the method is performed by execution of computer-readable software program codes or instructions by the at least one processor 12 of the electronic device 100. Depending on the embodiment, additional steps may be added, others removed, and the ordering of the steps may be changed.

In step S31, the display driving module 101 controls the video adaptor 5 to connect to the retina display 7, and controls the video driver 2 to drive the video adaptor 5 to activate a graphics display function of the retina display 7.

In step S32, the resolution analysis module 102 obtains a retina resolution of the retina display 7 and a standard resolution of an image currently displayed on the retina display 7 from the graphics engine 3. In the embodiment, the retina display 7 can have a display resolution between a standard resolution, such as 1366*768, and a retina resolution, such as 2732*1536. The standard resolution can correspond to a first display ratio (e.g., length*height represented by 4:3) of an image displayed on the retina display 7, and the retina resolution can correspond to a second display ratio (e.g., length*height represented by 16:9) of the image displayed on the retina display 7.

In step S33, the resolution analysis module 102 determines whether the retina resolution is greater than the standard resolution currently displayed on the retina display 7. If the retina resolution is greater than the standard resolution, step S34 is implemented. Otherwise, if the retina resolution is not greater than the standard resolution, step S37 is implemented.

In step S34, the resolution adjusting module 103 analyzes a display ratio of the image currently displayed on the retina display 7 according to the retina resolution. For example, the retina resolution is 2732*1536, the display ratio of the image currently displayed on the retina display 7 is 16:9.

In step S35, the resolution adjusting module 103 adjusts the standard resolution currently displayed on the retina display 7 to the retina resolution according to an image compensation algorithm. In the embodiment, the image compensation algorithm multiplies each pixel of the image currently displayed on the retina display 7, and displays the multiplied image on the retina display 7 without any size distortion.

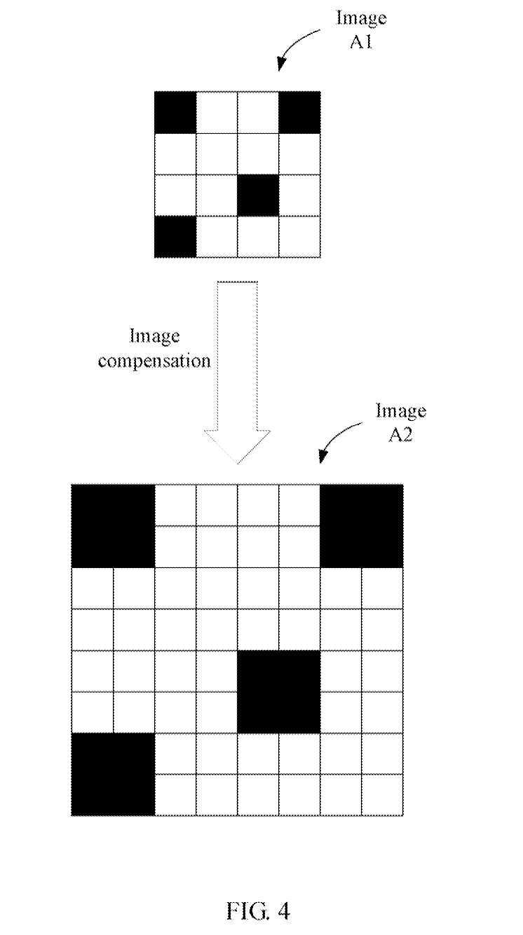

FIG. 4 is a schematic diagram illustrating one embodiment of an image compensation algorithm used to adjust a resolution of the retina display. In the embodiment, if an image A1 has 16 pixels, an image A2 having 64 pixels is obtained by multiplying each pixel of the image A1 by 4 according to the image compensation algorithm. Thus, the image A2 can be displayed on the retina display 7 without size distortion.

In step S36, the display module 104 controls the video driver 2 to display the multiplied image (i.e., image A2) on the retina display 7 according to the retina resolution (i.e., 2732*1536) and the display ratio (i.e., length*height represented by 16:9) through the video adaptor 5.

In step S37, the display module 104 controls the video driver 2 to display the original image (i.e., image A1) on the retina display 7 according to the standard resolution (i.e., 1366*768) through the video adaptor 5.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a graphics input-output (I/O) driver, a video driver, a graphics engine, an I/O manager, and a video adaptor connected to a retina display;
at least one processor; and
a storage device storing a computer-readable program comprising instructions that, which when executed by the at least one processor, causes the at least one processor to:
control the video adaptor to connect to the retina display, and control the video driver to drive the video adaptor to activate a graphics display function of the retina display;
obtain a retina resolution of the retina display and a standard resolution of an image currently displayed on the retina display from the graphics engine;
determine whether the retina resolution is greater than the standard resolution;
analyze a display ratio of the image currently displayed on the retina display according to the retina resolution when the retina resolution is greater than the standard resolution;
adjust the standard resolution to the retina resolution according to an image compensation algorithm; and
control the video driver to display the image on the retina display according to the retina resolution and the display ratio.

2. The electronic device according to claim 1, wherein the computer-readable program further causes the at least one processor to:
control the video driver to display the image on the retina display according to the standard resolution when the retina resolution is not greater than the standard resolution.

3. The electronic device according to claim 1, wherein the retina display has a display resolution between the standard resolution and the retina resolution.

4. The electronic device according to claim 1, wherein the image compensation algorithm multiplies each pixel of the image currently displayed on the retina display, and displays the image on the retina display without any size distortion.

5. The electronic device according to claim 1, wherein the electronic device comprises a user application layer, a kernel layer and a hardware layer defined by an operating system (OS) mode.

6. The electronic device according to claim 5, wherein the graphics I/O driver, the video driver, the graphics engine, and the I/O manager are included in the kernel layer, and the video adaptor is included in the hardware layer.

7. A method for driving a retina display of an electronic device, the electronic device comprising a graphics input-output (I/O) driver, a video driver, a graphics engine, an I/O manager, and a video adaptor, the method comprising:
controlling the video adaptor to connect to the retina display, and controlling the video driver to drive the video adaptor to activate a graphics display function of the retina display;
obtaining a retina resolution of the retina display and a standard resolution of an image currently displayed on the retina display from the graphics engine;
determining whether the retina resolution is greater than the standard resolution;
analyzing a display ratio of the image currently displayed on the retina display according to the retina resolution when the retina resolution is greater than the standard resolution;
adjusting the standard resolution to the retina resolution according to an image compensation algorithm; and
controlling the video driver to display the image on the retina display according to the retina resolution and the display ratio.

8. The method according to claim 7, further comprising:
controlling the video driver to display the image on the retina display according to the standard resolution when the retina resolution is not greater than the standard resolution.

9. The method according to claim 7, wherein the retina display has a display resolution between the standard resolution and the retina resolution.

10. The method according to claim 7, wherein the image compensation algorithm multiplies each pixel of the image currently displayed on the retina display, and displays the image on the retina display without any size distortion.

11. The method according to claim 7, wherein the electronic device comprises a user application layer, a kernel layer and a hardware layer defined by an operating system (OS) mode.

12. The method according to claim 11, wherein the graphics I/O driver, the video driver, the graphics engine, and the I/O manager are included in the kernel layer, and the video adaptor is included in the hardware layer.

13. A non-transitory storage medium having stored thereon instructions that, when executed by at least one processor of an electronic device, causes the processor to perform a method for driving a retina display of the electronic device, the electronic device comprising a graphics input-output (I/O) driver, a video driver, a graphics engine, an I/O manager, and a video adaptor, the method comprising:
controlling the video adaptor to connect to the retina display, and controlling the video driver to drive the video adaptor to activate a graphics display function of the retina display;
obtaining a retina resolution of the retina display and a standard resolution of an image currently displayed on the retina display from the graphics engine;
determining whether the retina resolution is greater than the standard resolution;
analyzing a display ratio of the image currently displayed on the retina display according to the retina resolution when the retina resolution is greater than the standard resolution;
adjusting the standard resolution to the retina resolution according to an image compensation algorithm; and
controlling the video driver to display the image on the retina display according to the standard resolution when the retina resolution is not greater than the standard resolution.

14. The non-transitory storage medium according to claim 13, wherein the method further comprises:
controlling the video driver to display the image on the retina display according to the standard resolution when the retina resolution is not greater than the standard resolution.

15. The non-transitory storage medium according to claim 13, wherein the retina display has a display resolution between the standard resolution and the retina resolution.

16. The non-transitory storage medium according to claim 13, wherein the image compensation algorithm multiplies each pixel of the image currently displayed on the retina display, and displays the image on the retina display without any size distortion.

17. The non-transitory storage medium according to claim 13, wherein the electronic device comprises a user application layer, a kernel layer and a hardware layer defined by an operating system (OS) mode.

18. The non-transitory storage medium according to claim 17, wherein the graphics I/O driver, the video driver, the graphics engine, and the I/O manager are included in the kernel layer, and the video adaptor is included in the hardware layer.
